(19) United States
(12) Patent Application Publication
(10) Pub. No.: US 2022/0366316 A1
(43) Pub. Date: Nov. 17, 2022

(54) ENSEMBLE MACHINE LEARNING FOR ANOMALY DETECTION

(71) Applicant: Capital One Services, LLC, McLean, VA (US)

(72) Inventors: Ashwin Assysh SHARMA, McLean, VA (US); Gunther Havel, McLean, VA (US)

(73) Assignee: Capital One Services, LLC, McLean, VA (US)

(21) Appl. No.: 17/318,883

(22) Filed: May 12, 2021

(51) Int. Cl. G06N 20/20; G06K 9/62; G06F 11/14

(52) U.S. Cl. CPC G06N 20/20; G06K 9/6268; G06K 9/6202; G06K 9/623; G06F 11/14

(57) ABSTRACT

Methods and systems are disclosed herein for using an ensemble machine learning approach to improve the ability of the computing system to detect anomalies. The computing system may use multiple machine learning models to identify one or more aspects of a dataset that correspond to anomalies. The aspects identified using a first machine learning model may be correlated with anomalies identified by a second machine learning model to reduce the number of false positive anomalies identified by the second machine learning model.

### BACKGROUND

In recent years, there has been an explosion in the amount of data being collected by organizations. More recently machine learning models have been developed to mine that data for various purposes. In particular, machine learning models have been developed to detect anomalies in data. For example, data from devices in a computer network may be collected and analyzed by a machine learning model to detect anomalies, which may indicate a security breach in the network. Given the large amount of data, there may be many false positives or records marked as anomalies when they are not actually anomalies. For example, based on mis-detecting anomalies in data received from one or more devices in the computer network, those devices may be misclassified as infected by malware or otherwise compromised. This may lead to false alarms which can waste computing resources. It may be difficult to determine whether an anomaly is a false positive or not.

### SUMMARY

To address these and other issues, a computing system may use an ensemble machine learning approach to improve the ability of the computing system to more accurately detect anomalies (e.g., identify false positives in anomaly detection). The computing system may use multiple machine learning models to identify one or more aspects (e.g., records, features, etc.) of a dataset that correspond to anomalies. The aspects identified using a first machine learning model may be correlated with anomalies identified by a second machine learning model to reduce the number of false positive anomalies identified by the second machine learning model. The computing system may use a first machine learning model to identify one or more features that are anomalous in a dataset. For example, the computing system may use a first machine learning model (e.g., an exponential moving average model, a statistical machine learning model, etc.) to determine that a first feature in a dataset (e.g., a time series dataset, etc.) is anomalous (e.g., in a given time period). For example, the computing system may use a first machine learning model to analyze a network traffic dataset and may determine that a first feature indicating the number of packets sent between 1 pm and 2 pm is anomalous. The computing system may use a second machine learning model (e.g., an isolation forest model, or other machine learning model) to classify one or more records in the dataset as anomalies, for example, based on features that correspond to each record. One or more of the records that are classified as anomalies by the second machine learning model may be false positives (e.g., one or more records may be classified as anomalies even though they are not anomalies or would not be considered anomalies by one or more standards). For example, the records in the network traffic dataset may correspond to computing devices in a computer network. In this example, the computing system may use a second machine learning model (e.g., a decision tree, neural network, random forest, isolation forest, etc.) to determine computing devices that have been infected with malware or otherwise compromised in the network (e.g., compromised computing devices may be considered anomalies).

The computing system may determine the impact value (e.g., Shapley additive explanations (SHAP) values) each feature (e.g., an individual measurable property or characteristic that is observed/recorded) had on classifying individual records as an anomaly. For example, a set of impact values may be generated for each record, with each impact value corresponding to one of the features of the record. An impact value may indicate the marginal contribution a feature had towards the classification of a record (e.g., the amount of influence the feature had in classifying a record as an anomaly or not). For example, the computing system may determine a set of impact values for a particular computing device that was determined to be compromised in the network traffic data. The computing system may compare the impact values of a record with the one or more features identified as anomalies by the first machine learning model. The computing system may determine that a record (e.g., that has been classified as an anomaly) is not a false positive (e.g., the computing system may confirm that the classification as an anomaly is correct), for example, if the one or more features identified by the first machine learning model are within a top number of features. For example, a record's classification as an anomaly may be confirmed if the first feature determined to be anomalous by the first machine learning model is within the top five features that have the greatest impact values for the record.

Using multiple machine learning models to confirm detected anomalies may reduce the number of false positives reported by a computer system. This may help one or more other computing systems (e.g., a downstream computing system, a monitoring system, etc.) identify problems and solve them more quickly (e.g., it may reduce the amount of computing resources required to fix problems with data, detect anomalies, detect compromised computing devices, etc.). Additionally or alternatively, reducing the number of false positive anomalies may allow systems that use machine learning models to produce better results (e.g., may output results with better accuracy, precision. etc.).

The computing system may receive a data file that includes rows and columns. The row in the data file may indicate records and the columns in the data file may indicate features to be used in a machine learning process (e.g., for anomaly detection). For example, the data file may include network traffic data. Each record in the network traffic data may correspond to a packet that has been sent in a computer network and columns in the network traffic data may correspond to features of a packet (e.g., data stored in the packet, destination, time sent, etc.). The computing system may determine, based on inputting the data file into a first machine learning model, a first feature or column that indicates that there is an anomaly in the data. For example, the computing system may determine based on inputting the network traffic data into a first machine learning model that a feature or column indicating the type of packet is anomalous in the network traffic data (e.g., because there are too many synchronize (SYN) type packets).

The computing system may use a second machine learning model to generate scores for each record in the data file. A score may indicate whether a corresponding record within the data file is an anomaly (e.g., if the score is above or below a threshold value). The computing system may use the scores to classify one or more records or rows in the data file as anomalies. For example, the computing system may generate a score for each packet in the network traffic data and may classify each packet as anomalous or not (e.g., if a corresponding score is above or below a threshold value).

The computing system may use impact values that indicate to what degree each feature had in determining the classification, and the first feature identified by the first machine learning model to determine whether a particular record is a false positive (e.g., whether the record should be confirmed as an anomaly or not). The computing system may determine a first set of impact values for a first record in the data file. Each impact value may indicate an influence a corresponding feature had on classifying the first row as an anomaly as compared with other impact values. For example, if the impact value for the feature “type of packet” is 56 and the impact value for the feature “time sent” is 32, the computing system may determine that the “type of packet” feature had a greater impact on classifying the row as an anomaly.

The computing system may determine a second set of impact values for the data file. The second set of impact values may be overall impact values and may indicate the influence a corresponding feature had on classifying each row in the data file. For example, a score of 87 for “type of packet” may represent the impact the “type of packet” feature had on classifying every row in the dataset. The computing system may determine a plurality of delta impact values for the first row by determining a difference (e.g., a pairwise difference) between the first plurality of impact values and the second plurality of impact values. For example, the computing system may subtract the impact values determined for the overall dataset from the impact values determined for an individual packet in the dataset.

The computing system may determine a row is not a false positive, for example, if the delta impact value corresponding to the first feature identified by the first machine learning model is within a top number of impact values (e.g., is greater than a threshold number of other delta impact values). For example, if a packet in the network traffic data has been classified as an anomaly and the delta impact value that corresponds to the “type of packet” feature (e.g., the feature identified by the first machine learning model as anomalous) is determined to be in a top number (e.g., top five, top 15, etc.) of features with the greatest impact, the computing system may determine that the packet's classification as an anomaly is not a false positive. In response to determining that the delta impact value corresponding to the first feature (e.g., a feature identified by the first machine learning model as anomalous) is greater than a threshold number of other delta impact values, the computing system may provide or send an indication that the first row corresponds to an anomaly.

Various other aspects, features, and advantages of the disclosure will be apparent through the detailed description of the disclosure and the drawings attached hereto. It is also to be understood that both the foregoing general description and the following detailed description are examples and not restrictive of the scope of the disclosure. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification “a portion,” refers to a part of, or the entirety of (i.e., the entire portion), a given item (e.g., data) unless the context clearly dictates otherwise.

### BRIEF DESCRIPTION OF THE DRAWINGS

FIG. 1 shows an example anomaly detection system for using machine learning to determine anomalies, in accordance with some embodiments.

FIG. 2 shows example output of a machine learning model, in accordance with some embodiments.

FIG. 3A shows example output of a machine learning model, in accordance with some embodiments.

FIG. 3B shows example impact values corresponding to features used in a machine learning model, in accordance with some embodiments.

FIG. 4 shows an example machine learning model, in accordance with some embodiments.

FIG. 5 shows an example computing system that may be used in accordance with some embodiments.

FIG. 6 shows an example flowchart of the actions involved in using machine learning to determine anomalies, in accordance with some embodiments.

### DETAILED DESCRIPTION

In the following description, for the purposes of explanation, numerous specific details are set forth in order to provide a thorough understanding of the disclosure. It will be appreciated, however, by those having skill in the art, that the disclosure may be practiced without these specific details or with an equivalent arrangement. In other cases, well-known structures and devices are shown in block diagram form to avoid unnecessarily obscuring the disclosure.

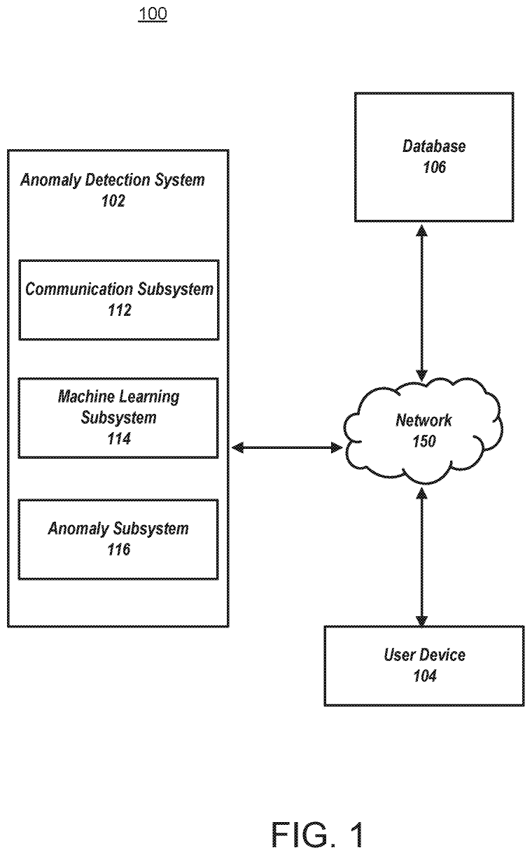

FIG. 1 shows an example computing system 100 for using machine learning to determine anomalies in data. The computing system 100 may use an ensemble machine learning approach to improve the ability of the computing system to detect anomalies. The computing system 100 may use multiple machine learning models to identify one or more aspects (e.g., features or records) of a dataset that correspond to anomalies. The aspects identified using a first machine learning model may be correlated with anomalies (e.g., anomalous features, anomalous records, etc.) identified by a second machine learning model to reduce the number of false positive anomalies identified by the second machine learning model. The computing system 100 may use a first machine learning model to identify one or more features that are anomalous in a dataset. For example, the computing system may use a first machine learning model (e.g., an exponential moving average model) to determine that a first feature in a dataset (e.g., a time series dataset, etc.) is anomalous (e.g., in a given time period). For example, the computing system may use a first machine learning model to analyze accounts data (e.g., banking accounts or other financial accounts) and may determine that a first feature indicating the number of transactions performed is anomalous for a set of accounts that were processed on a given day. The computing system may use a second machine learning model to classify one or more records in the dataset as anomalies, for example, based on features that correspond to each record. One or more of the records that are classified as anomalies by the second machine learning model may be false positives (e.g., one or more records may be classified as anomalies even though they are not anomalies or would not be considered anomalies by one or more standards). For example, the records or rows in the accounts data may correspond to individual accounts. In this example, the computing system may use a second machine learning model (e.g., a decision tree, neural network, random forest, etc.) to determine accounts that have been used for fraudulent activity (e.g., accounts used for fraudulent activity may be considered anomalies).

The computing system may determine the impact value each feature had on classifying individual records as an anomaly (e.g., a set of impact values may be generated for each record, with each impact value corresponding to one of the features of the record). An impact value may indicate the marginal contribution a feature had towards the classification of a record (e.g., the amount of influence the feature had in classifying a record as an anomaly or not). For example, the computing system may determine a set of impact values for a particular account that was determined to be used for fraudulent activity. The computing system may compare the impact values of a record with the one or more features identified as anomalies by the first machine learning model. The computing system may determine that a record (e.g., that has been classified as an anomaly) is not a false positive (e.g., the computing system may confirm that the classification as an anomaly is correct), for example, if the one or more features identified by the first machine learning model are within a top number of features. For example, an account's classification as an anomaly may be confirmed if the feature indicating the number of transactions (e.g., the first feature determined to be anomalous by the first machine learning model) is within the top five features that have the greatest impact on causing the second machine learning model to classify the account as an anomaly. Although some examples are provided throughout this disclosure, techniques described herein may be used with any type of data to confirm anomalies detected by one or more machine learning models and/or detect false positive anomalies that were mistakenly classified by one or more machine learning models (e.g., to improve the efficiency of one or more computing systems tasked with detecting anomalies).

The system 100 may include an anomaly detection system 102, a user device 104, and/or a database 106. The anomaly detection system 102 may include a communication subsystem 112, a machine learning (ML) subsystem 114, and/or an anomaly subsystem 116. The communication subsystem 112 may receive, from the database 106, a data file that includes rows (or records, instances, etc.) and columns (e.g., features) of a dataset. The data file may include time series data. The rows and columns may include data that may be used in a machine learning process. For example, a machine learning process may be used to determine whether there are errors in data so that the errors can be resolved before downstream systems perform further processing on the data. The data may include accounts for downstream processing and anomalies may indicate that a particular account should not be included for downstream processing (e.g., because it is a new account and only older accounts are to be processed by a downstream computing system). Rows in the data may indicate individual accounts in the data. Columns in the data may indicate features of the accounts.

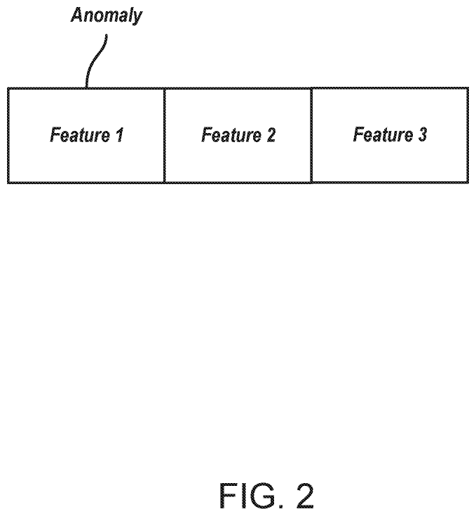

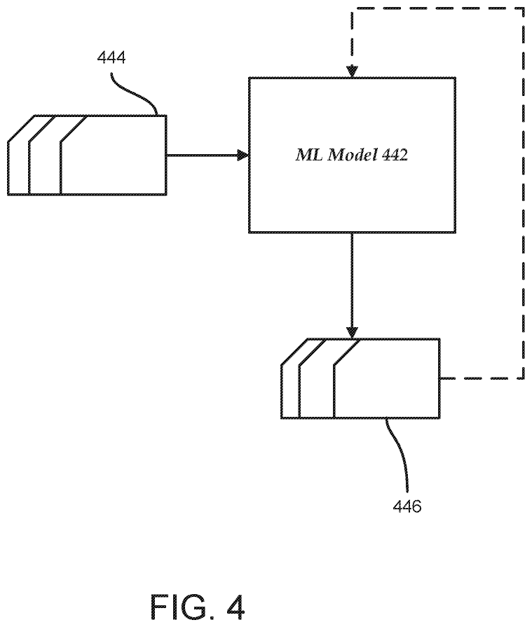

The ML subsystem 114 may input data (e.g., data received from the database 106) into a machine learning model. The machine learning model may be any type of machine learning model, for example, as discussed below in connection with FIG. 4. The machine learning model may be a moving average or exponential moving average model. The machine learning model may be configured to detect one or more features that indicate that there are anomalies in the input data. For example, the machine learning model may determine that a feature indicating the available balance in an account is associated with an anomaly. For example, the data for account processing may be a time series dataset and may have one dataset for each day. Each dataset may include accounts as rows and account features as columns. A feature indicating the available balance in accounts may be much higher on one day as compared to other days (e.g., the available balance may be summed across all accounts for each day and the summed value for each day may be compared with summed values for other days), which may be detected by the machine learning model. The machine learning model may output a feature that is associated with the anomaly. For example, with the account data, the machine learning model may output an indication that the available balance feature is associated with an anomaly. The machine learning model may output a plurality of features that are associated with an anomaly. For example, the machine learning model may output an indication that the available balance feature and a date created feature are both associated with anomalies in the data. Referring to FIG. 2, an example feature set with three features is shown. The machine learning model may output an indication that the first column (or feature 1) is anomalous (e.g., as compared to other features in the dataset).

Referring to FIG. 1, the ML subsystem 114 may input data (e.g., data received from the database 106) into a machine learning model to deter mine whether one or more records (e.g., rows in the data) are anomalous. The ML subsystem 114 may use the same machine learning model that was used to determine one or more features that are associated with anomalies (e.g., as described above) to determine whether one or more records are anomalous. Alternatively, the ML subsystem 114 may use a different machine learning model to determine whether one or more records are anomalous (e.g., the ML subsystem 114 may use any machine learning model described in connection with FIG. 4 below). The machine learning model may generate a score for each record or row in the data. The score may indicate whether the record is an anomaly or not. For example, the ML subsystem 114 may use an isolation forest model to output a score for each account in the account dataset described above. The machine learning model may be trained using prior data files. For example, if the data file corresponds to the 20^{th} day of the month, the machine learning model may be trained using the data corresponding to the 10^{th} through the 19^{th} day of the month. The ML subsystem 114 may use the scores output by the machine learning model to classify each row in the data as an anomaly. For example, the ML subsystem 114 may classify a row as an anomaly if the score for the row satisfies a threshold (e.g., the score is below a value or above a value). In some embodiments, the score for a record may indicate a confidence level of a classification of the record (e.g., with a higher score indicating higher confidence that the record should be considered an anomaly).

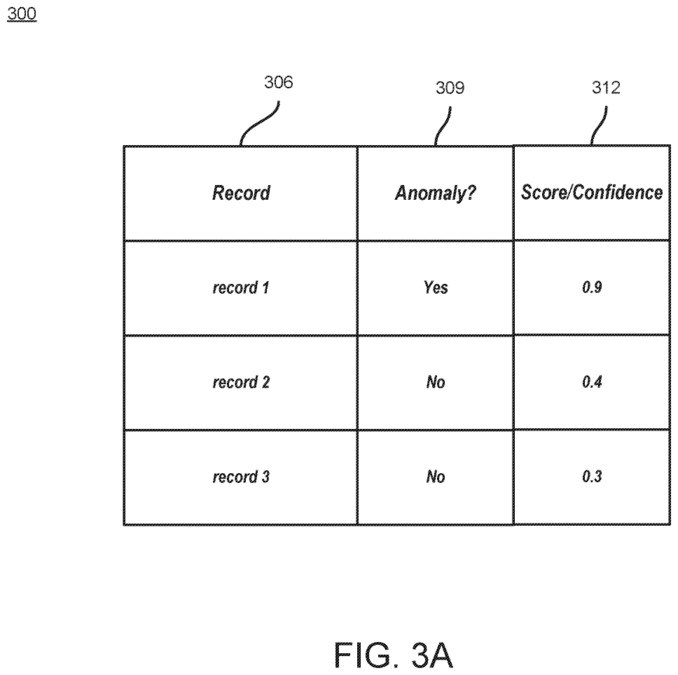

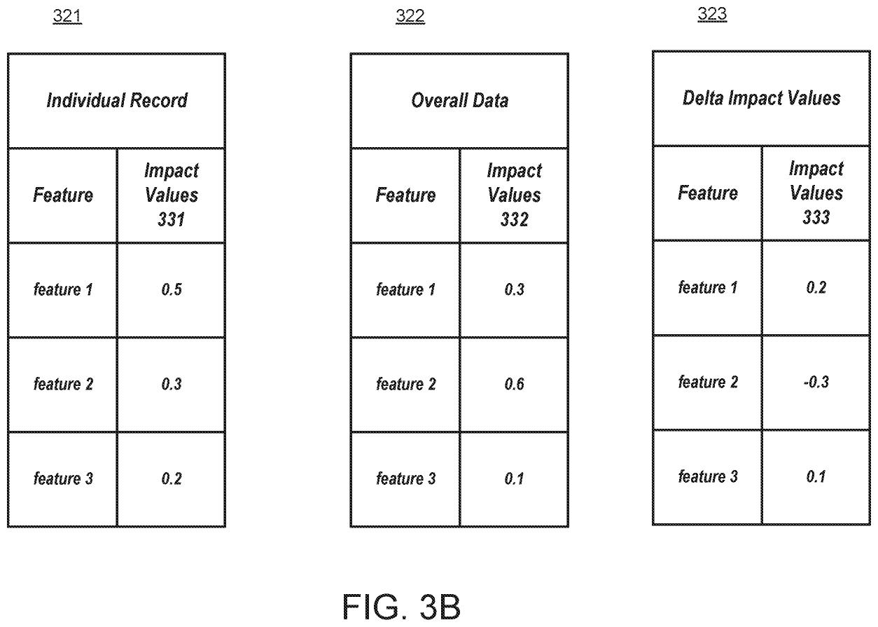

Referring to FIG. 3A, a table 300 with example scores and classifications of records is shown. The column 306 indicates records, the column 309 indicates the classification of records (e.g., as an anomaly or not an anomaly), and the column 312 indicates the score and/or confidence level for the classification. For example, a score of 0.9 was output for record 1 and the ML subsystem 114 classified record 1 as an anomaly (e.g., because the score 0.9 was higher than a threshold value of 0.6). As an additional example, a score of 0.4 was given to record 2 and the ML subsystem 114 classified record 2 as not anomalous (e.g., because the score of 0.4 was lower than the threshold value of 0.4). As an additional example, a score of 0.3 was given to record 3 and the ML subsystem 114 classified record 3 as not anomalous.

The ML subsystem 114 may determine the impact each feature within a row had on the row's classification. Impact values may be determined for each row in the data separately (e.g., each row may have its own set of impact values). The impact values may explain how the machine learning model was able to determine a classification for a row. An impact value may be generated for each feature in the row. An impact value may indicate the contribution a feature had to the rows classification by a machine learning model (e.g., or the score generated by the machine learning model for the rows). For example, referring to FIG. 3B, example impact values 331 are shown for an individual record 321. For example, the corresponding record 321 may have been classified as an anomaly. The impact values 331 may indicate the influence each feature had on the machine learning model's output that indicated record 321 was an anomaly. For example, the ML subsystem 114 may determine that the impact value for feature 1 was 0.5, the impact value for feature 2 was 0.3, and the impact value for feature 3 was 0.2. The impact values may be Shapley Additive exPlanations (SHAP) values, or another value generated by any other technique used for model interpretability.

Referring to FIG. 1, the ML subsystem 114 may determine a second set of impact values that apply to the dataset as a whole (e.g., an accounts dataset corresponding to one day, network traffic data corresponding to one week, or any other dataset). Each impact value in the second set of impact values may indicate an influence a corresponding feature had on classifying each row in the data file. For example, referring to FIG. 3B, table 322 shows example impact values 332 for an entire dataset. The impact values 332 may be an aggregate mean, average, sum, etc.) of the impact values determined for each feature of each row in the dataset. For example, the impact value for feature 1 (e.g., the marginal contribution that feature 1 had on classifying each record in the data) may be the average of the impact values for feature 1 of each row. The overall impact value for feature 1 on classifications for the dataset may be 0.3, the impact value for feature 2 on the dataset may be 0.6, and the impact value for feature 3 on the dataset may be 0.1.

Referring to FIG. 1, the ML subsystem may use the impact values determined for individual records and the impact values determined for the overall data to determine delta impact values for a particular record. The delta impact values may be the difference (e.g., pairwise difference) between the impact values of a row and the overall impact values. For example, referring to FIG. 3B, table 323 shows example delta impact values 333. Thu delta impact values 333 may be calculated by taking the pairwise difference between the impact values 331 and the impact values 332. For example, the delta impact value for feature 1 is 0.2 (e.g., 0.5 for feature 1 in impact values 331 minus 0.3 for feature 1 in impact values 332). For example, the ML subsystem 114 may determine a first set of SNAP values for an account in the account dataset and a second set of SHAP values corresponding to each account in the dataset. In this example, the dataset may include accounts that are to be processed for a given day and the anomaly detection system 102 may be tasked with determining whether there are any accounts present in the dataset that should not be processed. The accounts that should not be processed may be considered anomalies by the anomaly detection system 102.

The ML subsystem 114 may correlate the delta impact values with the feature identified as an anomalous feature (e.g., as described above). One or more records classified as anomalies by the machine learning model may be false positives (e.g., they may be classified as anomalies when they should instead be classified as not anomalies). The anomaly detection system 102 may be able to reduce the number of false positives by correlating the results one or more machine learning models (e.g., by correlating the output of a first machine learning model that identifies a feature associated with an anomaly with the delta impact values for a record that was classified as an anomaly). The ML subsystem 114 may rank the features of a record, for example, in order of greatest delta impact value to least delta impact value (e.g., because each feature has an associated delta impact value). The ML subsystem 114 may determine if the feature that was determined to be associated with anomalies by a first machine learning model is in a top number (e.g., the top 5 most impactful features (e.g., as indicated by the delta impact values), the top 10 most impactful features, etc.) of features. For example, referring to FIG. 2, a first machine learning model may determine that feature 1 of a dataset is associated with an anomaly in the dataset (e.g., a time series dataset where a dataset is generated each day with accounts as rows and features of the accounts as columns). For example, the feature 1 may correspond to a feature indicating the available balance in an account. :A second machine learning model may be used to determine the delta impact values for an account in the dataset used by the first machine learning model. For example, referring to FIG. 3B, the second machine learning model may be used to determine the delta impact values 333. The ML subsystem 114 may correlate the results of the first machine learning model with the second machine learning model. For example, the ML subsystem 114 may determine that the record 321 was not labeled incorrectly as an anomaly (e.g., the classification of record 321 as an anomaly is not a false positive), for example, because feature 1 was identified by the first machine learning model as being associated with an anomaly in the dataset and feature 1 is the feature associated with the highest delta impact value for the record 321. Additionally or alternatively, the ML subsystem 114 may determine that a record is not a false positive, for example, because the delta impact value for feature 1 is greater than a threshold number (e.g., 5, 3, 10, etc.) of delta impact values for other features and feature 1 is an anomalous feature determined by an additional machine learning model.

In some embodiments, the ML subsystem 114 may change the classification of a record from anomaly to not an anomaly. The ML subsystem 114 may change the classification for example, if the delta impact value or impact value associated with an anomalous feature (e.g., determined by the first machine learning model as discussed above) is not greater than a threshold number of other delta impact values associated with the record. For example, if feature 1 is the anomalous feature and a delta impact value associated with the feature 1 is not within the top five delta impact values for the record, the ML subsystem 114 may modify the classification of the record from anomaly to not anomaly (e.g., the ML subsystem 114 may determine that the record was a false positive).

Referring to FIG. 1, the anomaly subsystem 116 may provide an indication that a record is an anomaly or is not an anomaly. For example, referring to FIG. 3B, the anomaly subsystem 116 may send an alert to a computing system indicating that the record 321 has been confirmed to be an anomaly and/or is not a false positive. The anomaly subsystem 116 may provide the indication that the record 321 is an anomaly and/or that the record has been confirmed to be an anomaly and/or that the record 321 is not a false positive, for example, in response to determining that the first delta impact value (e.g., for feature 1) is greater than a threshold number of other delta impact values (e.g., greater than two other delta impact values).

In some embodiments, the ML subsystem 114 may calculate delta impact values for a plurality of rows in the data (e.g., for every row in the data, for every row that was classified as an anomaly, etc.) and may confirm the classification of the row as an anomaly or as not anomalous. The anomaly subsystem 116 may send an indication of each row that was confirmed to be anomalous (e.g., each row that was determined to not be a false positive by comparing the feature identified by a first machine learning model as anomalous with the delta impact values as described above). The anomaly subsystem 116 may send an indication of a subset of the rows that were confirmed to be anomalous. For example, the anomaly subsystem may sort each row by the score that was used to classify each row as an anomaly (e.g., the scores described in column 312 of FIG. 2). The anomaly subsystem 116 may send an indication of a predetermined number (e.g., 50, 100, 15, etc.) of the rows that have the highest score and/or that were confirmed to not be false positives (e.g., by comparing the feature identified by a first machine learning model as anomalous with the delta impact values as described above). By sending an indication of a subset of the rows (e.g., rows with higher or lower than a threshold score), the anomaly detection system 102 may reduce the amount of data that a computing system has to process and/or the amount of data that a human operator may need to examine in response to an alert indicating anomalies in a dataset (e.g., which may increase the efficiency of the computing system).

Referring to FIG. 1, the user device 104 may be any computing device, including, but not limited to, a laptop computer, a tablet computer, a hand-held computer, smartphone, other computer equipment (e.g., a server or virtual server), including “smart,” wireless, wearable, and/or mobile devices. Although only one user device 104 is shown, the system 100 may include any number of client devices, which may be configured to receive messages/reminders from the anomaly detection system 102 via the network 150. A user may use the user device 104 to send a request to the anomaly detection system 102 to perform techniques described herein (e.g., to determine anomalies in a dataset as described above).

The anomaly detection system 102 may include one or more computing devices described above and/or may include any type of mobile terminal, fixed terminal, or other device. For example, the anomaly detection system 102 may be implemented as a cloud computing system and may feature one or more component devices. A person skilled in the art would understand that system 100 is not limited to the devices shown in FIG. 1. Users may, for example, utilize one or more other devices to interact with devices, one or more servers, or other components of system 100. A person skilled in the art would also understand that while one or more operations are described herein as being performed by particular components of the system 100, those operations may, in some embodiments, be performed by other components of the system 100. As an example, while one or more operations are described herein as being performed by components of the anomaly detection system 102, those operations may be performed by components of the user device 104, and/or database 106. In some embodiments, the various computers and systems described herein may include one or more computing devices that are programmed to perform the described functions. Additionally or alternatively, multiple users may interact with system 100 and/or one or more components of system 100. For example, a first user and a second user may interact with the anomaly detection system 102 using two different client devices.

In some embodiments, the anomaly detection system 102 may be part of the user device 104. Providing a message may include outputting a sound, displaying an element in a user interface, vibrating the user device 104, sending information to the user device 104 (e.g., that causes the user device 104 to display a notification), or any other way of providing a notification that may be known to a person of ordinary skill in the art. In some embodiments, the anomaly detection system 102 and the user device 104 may be separate devices and providing a message may include sending, by the anomaly detection system 102, the message to the user device 104.

One or more components of the anomaly detection system 102, user device 104, and/or database 106, may receive content and/or data via input/output (hereinafter “I/O”) paths. The one or more components of the anomaly detection system 102, the user device 104, and/or the database 106 may include processors and/or control circuitry to send and receive commands, requests, and other suitable data using the I/O paths. The control circuitry may include any suitable processing, storage, and/or input/output circuitry. Each of these devices may include a user input interface and/or user output interface (e.g., a display) for use in receiving and displaying data. It should be noted that in some embodiments, the anomaly detection system 102, the user device 104, and/or the database 106 may have neither user input interface nor displays and may instead receive and display content using another device (e.g., a dedicated display device such as a computer screen and/or a dedicated input device such as a remote control, mouse, voice input, etc.). Additionally, the devices in system 100 may run an application (or another suitable program). The application may cause the processors and/or control circuitry to perform operations related to determining anomalies and/or false positives in a dataset.

One or more components and/or devices in the system 100 may include electronic storages. The electronic storages may include non-transitory storage media that electronically stores information. The electronic storage media of the electronic storages may include one or both of (a) system storage that is provided integrally (e.g., substantially non-removable) with servers or client devices or (ii) removable storage that is removably connectable to the servers or client devices for example, a port (e.g., a USB port, a FireWire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 1 also includes a network 150. The network 150 may be the Internet, a mobile phone network, a mobile voice or data network (e.g., a 5G or LTE network), a cable network, a public switched telephone network, a combination of these networks, or other types of communications networks or combinations of communications networks. The devices in FIG. 1 (e.g., anomaly detection system 102, the user device 104, and/or the database 106) may communicate (e.g., with each other or other computing systems not shown in FIG. 1) via the network 150 using one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The devices in FIG. 1 may include additional communication paths linking hardware, software, and/or firmware components operating together. For example, the anomaly detection system 102, any component of the notification system (e.g., the communication subsystem 112, the ML subsystem 114, and/or the anomaly subsystem 116), the user device 104, and/or the database 106 may be implemented by one or more computing platforms.

One or more machine learning models discussed above may be implemented (e.g., in part), for example, as shown in FIG. 4. With respect to FIG. 4, machine learning model 442 may take inputs 444 and provide outputs 446. In one use case, outputs 446 may be fed back to machine learning model 442 as input to train machine learning model 442 (e.g., alone or in conjunction with user indications of the accuracy of outputs 446, labels associated with the inputs, or with other reference feedback information). In another use case, machine learning model 442 may update its configurations (e.g., weights, biases, or other parameters) based on its assessment of its prediction (e.g., outputs 446) and reference feedback information (e.g., user indication of accuracy, reference labels, or other information). In another example use case, where machine learning model 442 is a neural network and connection weights may be adjusted to reconcile differences between the neural network's prediction and the reference feedback. In a further use case, one or more neurons (or nodes) of the neural network may require that their respective errors are sent backward through the neural network to them to facilitate the update process (e.g., backpropagation of error). Updates to the connection weights may, for example, be reflective of the magnitude of error propagated backward after a forward pass has been completed. In this way, for example, the machine learning model 442 may be trained to generate results (e.g., detect anomalies, classify data, generate predictions, etc.) with better recall and/or precision.

In some embodiments, the machine learning model 442 may include an artificial neural network. In some embodiments, machine learning model 442 may include an input layer and one or more hidden layers. Each neural unit of the machine learning model may be connected with one or more other neural units of the machine learning model 442. Such connections can be enforcing or inhibitory in their effect on the activation state of connected neural units. Each individual neural unit may have a summation function which combines the values of all of its inputs together. Each connection (or the neural unit itself) may have a threshold function that a signal must surpass before it propagates to other neural units. The machine learning model 442 may be self-learning and/or trained, rather than explicitly programmed, and may perform significantly better in certain areas of problem solving, as compared to computer programs that do not use machine learning. During training, an output layer of the machine learning model 442 may correspond to a classification, and an input known to correspond to that classification may be input into an input layer of the machine learning model during training. During testing, an input without a known classification may be input into the input layer, and a determined classification may be output. For example, the classification may be an indication of whether a record or instance is an anomaly or not. The machine learning model 442 trained by the ML subsystem 114 may include one or more embedding layers at which information or data (e.g., any data or information discussed above in connection with FIGS. 1-4) is converted into one or more vector representations. The one or more vector representations of the message may be pooled at one or more subsequent layers to convert the one or more vector representations into a single vector representation.

The machine learning model 442 may be structured as a factorization machine model. The machine learning model 442 may be a non-linear model and/or supervised learning model that can perform classification and/or regression. For example, the machine learning model 442 may be a general-purpose supervised learning algorithm that the system uses for both classification and regression tasks. The machine learning model 442 may include a Bayesian model configured to perform variational inference, for example, to predict whether an action will be completed by the deadline, and/or a communication protocol to use for sending a message (e.g., a reminder message). The machine learning model 442 may include an isolation forest model, an exponential moving average model, or any other type of machine learning model.

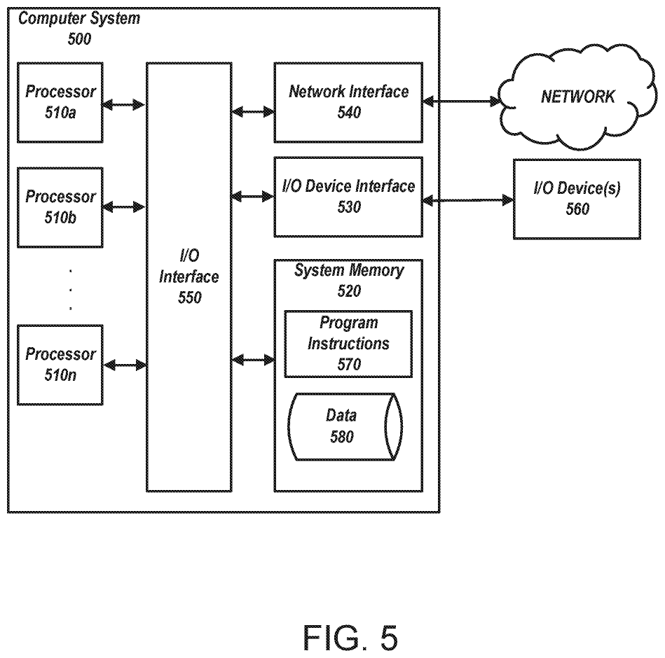

FIG. 5 is a diagram that illustrates an exemplary computing system 500 in accordance with embodiments of the present technique. Various portions of systems and methods described herein, may include or be executed on one or more computer systems similar to computing system 500. Further, processes and modules described herein may be executed by one or more processing systems similar to that of computing system 500.

Computing system 500 may include one or more processors (e.g., processors 510a-510n) coupled to system memory 520, an input/output I/O device interface 530, and a network interface 540 via an input/output (I/O) interface 550. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 500. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 520). Computing system 500 may be a units-processor system including one processor (e.g., processor 510a), or a multi-processor system including any number of suitable processors (e.g., 510a-510n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 500 may include a plurality of computing devices (e.g., distributed computer systems) to implement various processing functions.

I/O device interface 530 may provide an interface for connection of one or more I/O devices 560 to computer system 500. I/O devices may include devices that receive input (e.g., from a user) or output information (e.g., to a user). I/O devices 560 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 560 may be connected to computer system 500 through a wired or wireless connection. I/O devices 560 may be connected to computer system 500 from a remote location. I/O devices 560 located on remote computer system, for example, may be connected to computer system 500 via a network and network interface 540.

Network interface 540 may include a network adapter that provides for connection of computer system 500 to a network. Network interface 540 may facilitate data exchange between computer system 500 and other devices connected to the network. Network interface 540 may support wired or wireless communication. The network may include an electronic communication network, such as the Internet, a local area network (LAN), a wide area network (WAN), a cellular communications network, or the like.

System memory 520 may be configured to store program instructions 570 or data 580. Program instructions 570 may be executable by a processor (e.g., one or more of processors 510a-510n) to implement one or more embodiments of the present techniques. Instructions 570 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more) (Jules, sub programs, or portions of code). A computer program may be deployed to be executed on one or more computer processors located locally at one site or distributed across multiple remote sites and interconnected by a communication network.

System memory 520 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 520 may include a non-transitory computer readable storage medium that may have program instructions stored thereon that are executable by a computer processor (e.g., one or more of processors 510a-510n) to cause the subject matter and the functional operations described herein. A memory (e.g., system memory 520) may include a single memory device and/or a plurality of memory devices (e.g., distributed memory devices).

I/O interface 550 may be configured to coordinate I/O traffic between processors 510a-510n, system memory 520, network interface 540, I/O devices 560, and/or other peripheral devices. I/O interface 550 may perform protocol, timing, or other data transformations to convert data signals from one component (e.g., system memory 520) into a format suitable for use by another component (e.g., processors 510a-510n). I/O interface 550 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 500 or multiple computer systems 500 configured to host different portions or instances of embodiments. Multiple computer systems 500 may provide for parallel or sequential processing/execution of one or more portions of the techniques described herein.

Those skilled in the art will appreciate that computer system 500 is merely illustrative and is not intended to limit the scope of the techniques described herein. Computer system 500 may include any combination of devices or software that may perform or otherwise provide for the performance of the techniques described herein. For example, computer system 500 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 500 may also be connected to other devices that are not illustrated and/or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. In some embodiments, some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 500 may be transmitted to computer system 500 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present disclosure may be practiced with other computer system configurations.

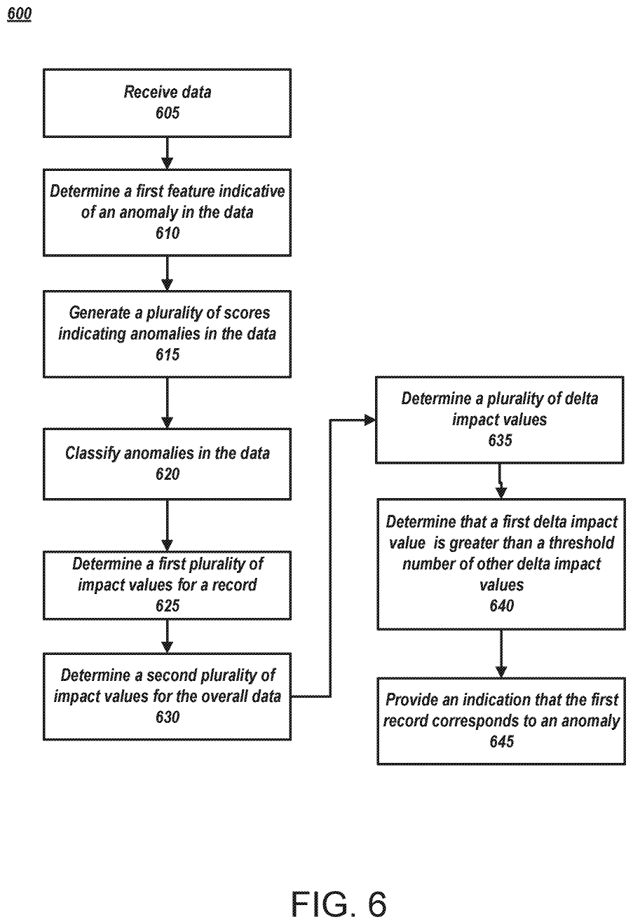

FIG. 6 shows an example flowchart of the actions involved in using machine learning to determine anomalies. For example, process 600 may represent the actions taken by one or more devices shown in FIGS. 1-5 and described above. At 605, anomaly detection system 102 (e.g., using one or more components in system 100 (FIG. 1) and/or computer system 500 via network interface 540 (FIG. 5)) may receive data. The data may include rows and columns. The rows in the data may indicate records (e.g., instances). The columns in the data may indicate features to be used in a machine learning process.

At 610, anomaly detection system 102 (e.g., using one or more components in system 100 (FIG. 1) and/or computing system 500 via one or more processors 510a-510n and system memory 520 (FIG. 5)) may determine at least a first feature indicative of an anomaly in the data. The anomaly detection system 102 may input the data into a first machine learning model (e.g., a machine learning model 442 as described in connection with FIG. 4) to determine one or more features indicative of one or more anomalies in the data. The one or more features may correspond to one or more columns in the data.

At 615, anomaly detection system 102 (e.g., using one or more components in system 100 (FIG. 1) and/or computing system 500 via one or more processors 510a-510n, 110 interface 550, and/or system memory 520 (FIG. 5)) may generate a plurality of scores indicating anomalies in the data. The anomaly detection system 102 may input the data into a second machine learning model (e.g., a machine learning model 442 as described in connection with FIG. 4) and the second machine learning model may output the plurality of scores. Each score may indicate whether a corresponding row within the data file corresponds to an anomaly within the data file. Each score may indicate whether the row it corresponds to should be classified as an anomaly. The first machine learning model and the second machine learning model may be the same machine learning model or different machine learning models.

At 620, anomaly detection system 102 (e.g., using one or more components in system 100 (FIG. 1) and/or computing system 500 via one or more processors 510a-510n (FIG. 5)) may classify anomalies in the data. The anomaly detection system 102 may classify a row as an anomaly, for example, if a score for the row satisfies a threshold (e.g., is above a threshold value). Otherwise, the anomaly detection system 102 may provide a classification to a row indicating that the row is not an anomaly.

At 625, anomaly detection system 102 (e.g., using one or more components in system 100 (FIG. 1) and/or computing system 500 (FIG. 5)) may determine a first plurality of impact values for a record (e.g., a row). Each impact value in the first plurality of impact values may indicate an influence a corresponding feature had on classifying the first record as an anomaly (e.g., as compared with other impact values of the first plurality of impact values).

At 630, anomaly detection system 102 (e.g., using one or more components in system 100 (FIG. 1) and/or computing system 500 via the network interface 540 (FIG. 5)) may determine a second plurality of impact values for the overall data. The second plurality of impact values may indicate the impact a feature had on classifying all of the records in the data (e.g., the average impact a feature had on classifying records in the dataset).

At 635, anomaly detection system 102 (e.g., using one or more components in system 100 (FIG. 1) and/or computing system 500 via one or more processors 510a-510n (FIG. 5)) may determine a plurality of delta impact values. The delta impact values may be determined by taking the difference between the first plurality of impact values and the second plurality of impact values. The delta impact values may be a pairwise difference between the first plurality of impact values and the second plurality of impact values.

At 640, anomaly detection system 102 (e.g., using one or more components in system 100 (FIG. 1) and/or computing system 500 via one or more processors 510a-510n (FIG. 5)) may determine that one or more delta impact values is greater than (or in some embodiments, less than) a threshold number of other delta impact values (e.g., that the one or more delta impact values is in a top number of delta impact values, for example, when sorted in ascending or descending order). Each of the one or delta impact values may correspond to one feature of the one or more features determined at 610.

At 645, anomaly detection system 102 (e.g., using one or more components in system 100 (FIG. 1) and/or computing system 500 via one or more processors 510a-510n (FIG. 5)) may provide an indication that the first record is an anomaly. Additionally or alternatively, the anomaly detection system 102 may provide an indication that the first record is not a false positive or that the first record has been confirmed to be an anomaly. The anomaly detection system 102 may provide the indication, for example, in response to determining that the one or more delta impact values are greater than (or less than) a threshold number of other delta impact values.

It is contemplated that the actions or descriptions of FIG. 6 may be used with any other embodiment of this disclosure. In addition, the actions and descriptions described in relation to FIG. 6 may be done in alternative orders or in parallel to further the purposes of this disclosure. For example, each of these actions may be performed in any order, in parallel, or simultaneously to reduce lag or increase the speed of the system or method. Furthermore, it should be noted that any of the devices or equipment discussed in relation to FIGS. 1-5 could be used to perform one or more of the actions in FIG. 6.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g., within a data center or geographically), or otherwise differently organized. The functionality described herein may be provided by one or more processors of one or more computers executing code stored on a tangible, non-transitory, machine readable medium. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several disclosures. Rather than separating those disclosures into multiple isolated patent applications, applicants have grouped these disclosures into a single document because their related subject matter lends itself to economies in the application process. However, the distinct advantages and aspects of such disclosures should not be conflated. In some cases, embodiments address all of the deficiencies noted herein, but it should be understood that the disclosures are independently useful, and some embodiments address only a subset of such problems or offer other, unmentioned benefits that will be apparent to those of skill in the art reviewing the present disclosure. Due to costs constraints, some features disclosed herein may not be presently claimed and may be claimed in later filings, such as continuation applications or by amending the present claims. Similarly, due to space constraints, neither the Abstract nor the Summary sections of the present document should be taken as containing a comprehensive listing of all such disclosures or all aspects of such disclosures.

It should be understood that the description and the drawings are not intended to limit the disclosure to the particular form disclosed, but to the contrary, the intention is to cover all modifications, equivalents, and alternatives falling within the spirit and scope of the present disclosure as defined by the appended claims. Further modifications and alternative embodiments of various aspects of the disclosure will be apparent to those skilled in the art in view of this description. Accordingly, this description and the drawings are to be construed as illustrative only and are for the purpose of teaching those skilled in the art the general manner of carrying out the disclosure. It is to be understood that the forms of the disclosure shown and described herein are to be taken as examples of embodiments. Elements and materials may be substituted for those illustrated and described herein, parts and processes may be reversed or omitted, and certain features of the disclosure may be utilized independently, all as would be apparent to one skilled in the art after having the benefit of this description of the disclosure. Changes may be made in the elements described herein without departing from the spirit and scope of the disclosure as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing actions A, B, C, and D) encompasses both all such attributes or functions being mapped to all such objects and subsets of the attributes or functions being mapped to subsets of the attributes or functions (e.g., both all processors each performing actions A-D, and a case in which processor 1 performs action A, processor 2 performs action B and part of action C, and processor 3 performs part of action C and action D), unless otherwise indicated. Further, unless otherwise indicated, statements that one value or action is “based on” another condition or value encompass both instances in which the condition or value is the sole factor and instances in which the condition or value is one factor among a plurality of factors. The term “each” is not limited to “each and every” unless indicated otherwise. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method comprising: receiving data; determining a first feature indicative of an anomaly in the data; classifying one or more records in the data as an anomaly; determining a plurality of impact values corresponding to a first record of the plurality of records; determining that a first impact value of the plurality of impact values is greater than a threshold number of other impact values of the plurality of impact values; and based on determining that a first impact value of the plurality of impact values is greater than a threshold number of other impact values of the plurality of impact values, outputting an indication that the first record corresponds to an anomaly.
2. The method of any of the preceding embodiments, wherein the determining a plurality of impact values comprises: determining a first plurality of impact values for a first record of the plurality of records, wherein each impact value in the first plurality of impact values indicates an influence a corresponding feature had on classifying the first record as an anomaly; determining a second plurality of impact values for the data, wherein each impact value in the second plurality of impact values indicates an influence a corresponding feature had on classifying each record in the data; and determining a plurality of impact values for the first record by determining a pairwise difference between the first plurality of impact values and the second plurality of impact values.
3. The method of any of the preceding embodiments, wherein the determining a second plurality of impact values for the data comprises averaging impact values of each record in the data.
4. The method of any of the preceding embodiments, wherein the data comprises time series data corresponding to a first day, and wherein the second machine learning model is trained on a second data file corresponding to a predetermined number of days prior to the first day.
5. The method of any of the preceding embodiments, wherein determining that a first impact value of the plurality of impact values is greater than a threshold number of other impact values of the plurality of impact values comprises: ranking, based on the plurality of impact values, each feature of the first record; and determining, based on the ranking, that the first feature is ranked in a top predetermined number of features.
6. The method of any of the preceding embodiments, wherein outputting an indication that the first record corresponds to an anomaly is further based on a determination that a score of the plurality of scores that corresponds to the first record is above a threshold score.
7. The method of any of the preceding embodiments, wherein outputting an indication that the first record corresponds to an anomaly is performed in response to: sorting, based on the plurality of scores, each record of the data; and determining that the first record is above a threshold order in the sorted data.
8. The method of any of the preceding embodiments, wherein determining that a first impact value of the plurality of impact values is greater than a threshold number of other impact values of the plurality of impact values comprises determining that the first impact value is greater than every other impact value.
9. A tangible, non-transitory, machine-readable medium storing instructions that, when executed by a data processing apparatus, cause the data processing apparatus to perform operations comprising those of any of embodiments 1-8.
10. A system comprising: one or more processors; and memory storing instructions that, when executed by the processors, cause the processors to effectuate operations comprising those of any of embodiments 1-8.
11. A system comprising means for performing any of embodiments 1-8.

What is claimed is:

1. A system for using an ensemble machine learning model to detect anomalies, the system comprising:
one or more processors and computer program instructions that, when executed, cause the one or more processors to perform operations comprising:
receiving a data file comprising rows and columns, wherein the rows in the data file indicate records and the columns in the data file indicate features to be used in a machine learning process;
determining, based on inputting the data file into a first machine learning model, a first feature indicative of an anomaly in the data file, wherein the first feature corresponds to data within a first column within the data file;
generating, based on inputting the data file into a second machine learning model, a plurality of scores, wherein each score indicates whether a corresponding row within the data file corresponds to an anomaly within the data file;
classifying, based on the plurality of scores, a plurality of rows as anomalies;
determining a first plurality of impact values for a first row of the plurality of rows, wherein each impact value in the first plurality of impact values indicates an influence a corresponding feature had on classifying the first row as an anomaly as compared with other impact values of the first plurality of impact values;
determining a second plurality of impact values for the data file, wherein each impact value in the second plurality of impact values indicates an influence a corresponding feature had on classifying each row in the data file;
determining a plurality of delta impact values for the first row by determining a pairwise difference between the first plurality of impact values and the second plurality of impact values;
determining that a first delta impact value of the plurality of delta impact values is greater than a threshold number of other delta impact values of the plurality of delta impact values, wherein the first delta impact value corresponds to the first feature; and
in response to determining that the first delta impact value is greater than a threshold number of other delta impact values, providing an indication that the first row corresponds to an anomaly.

2. The system of claim 1, wherein the data file comprises time series data corresponding to a first day, and wherein the second machine learning model is trained on a second data file corresponding to a predetermined number of days prior to the first day.

3. The system of claim 1, wherein the instructions for determining that a first delta impact value of the plurality of delta impact values is greater than a threshold number of other delta impact values of the plurality of delta impact values, when executed, cause operations further comprising:
ranking, based on the plurality of delta impact values, each feature of the first row; and
determining, based on the ranking, that the first feature is ranked in a top predetermined number of features.

4. The system of claim 1, wherein providing an alert indicating that the first row corresponds to an anomaly is further based on a determination that a score of the plurality of scores that corresponds to the first row is above a threshold score.

5. A method comprising:
receiving data comprising records and features, wherein the records comprise one or more anomalies;
determining, based on inputting the data into a first machine learning model, a first feature indicative of an anomaly in the data;
generating, based on inputting the data into a second machine learning model, a plurality of scores, wherein each score indicates whether a corresponding record in the data is an anomaly;
classifying, based on the plurality of scores, a plurality of records as anomalies;
determining a plurality of delta impact values corresponding to a first record of the plurality of records, wherein the plurality of delta impact values indicate an influence the first feature had on classifying the first record as an anomaly, wherein the plurality of delta impact values indicate a difference between impact values corresponding to the first record and impact values corresponding to each record of the data;
determining that a first delta impact value of the plurality of delta impact values is greater than a threshold number of other delta impact values of the plurality of delta impact values, wherein the first delta impact value corresponds to the first feature; and
based on determining that a first delta impact value of the plurality of delta impact values is greater than a threshold number of other delta impact values of the plurality of delta impact values, outputting an indication that the first record corresponds to an anomaly.

6. The method of claim 5, wherein the determining a plurality of delta impact values comprises:
determining a first plurality of impact values for a first record of the plurality of records, wherein each impact value in the first plurality of impact values indicates an influence a corresponding feature had on classifying the first record as an anomaly;
determining a second plurality of impact values for the data, wherein each impact value in the second plurality of impact values indicates an influence a corresponding feature had on classifying each record in the data; and
determining a plurality of delta impact values for the first record by determining a pairwise difference between the first plurality of impact values and the second plurality of impact values.

7. The method of claim 6, wherein the determining a second plurality of impact values for the data comprises averaging impact values of each record in the data.

8. The method of claim 5, wherein the data comprises time series data corresponding to a first day, and wherein the second machine learning model is trained on a second data file corresponding to a predetermined number of days prior to the first day.

9. The method of claim 5, wherein determining that a first delta impact value of the plurality of delta impact values is greater than a threshold number of other delta impact values of the plurality of delta impact values comprises:
ranking, based on the plurality of delta impact values, each feature of the first record; and
determining, based on the ranking, that the first feature is ranked in a top predetermined number of features.

10. The method of claim 5, wherein outputting an indication that the first record corresponds to an anomaly is further based on a determination that a score of the plurality of scores that corresponds to the first record is above a threshold score.

11. The method of claim 5, wherein outputting an indication that the first record corresponds to an anomaly is performed in response to:
sorting, based on the plurality of scores, each record of the data; and
determining that the first record is above a threshold order in the sorted data.

12. The method of claim 5, wherein determining that a first delta impact value of the plurality of delta impact values is greater than a threshold number of other delta impact values of the plurality of delta impact values comprises determining that the first delta impact value is greater than every other delta impact value.

13. A tangible, non-transitory, machine-readable medium storing instructions that when executed by one or more processors effectuate operations comprising:
receiving data comprising records and features, wherein the records comprise one or more anomalies;
determining, based on inputting the data into a first machine learning model, a first feature indicative of an anomaly in the data;
generating, based on inputting the data into a second machine learning model, a plurality of scores, wherein each score indicates whether a corresponding record in the data is an anomaly;
classifying, based on the plurality of scores, a plurality of records as anomalies;
determining a plurality of delta impact values corresponding to a first record of the plurality of records, wherein the plurality of delta impact values indicate an influence the first feature had on classifying the first record as an anomaly, wherein the plurality of delta impact values indicate a difference between impact values corresponding to the first record and impact values corresponding to each record of the data;
determining that a first delta impact value of the plurality of delta impact values is greater than a threshold number of other delta impact values of the plurality of delta impact values, wherein the first delta impact value corresponds to the first feature; and
based on determining that a first delta impact value of the plurality of delta impact values is greater than a threshold number of other delta impact values of the plurality of delta impact values, outputting an indication that the first record corresponds to an anomaly.

14. The medium of claim 13, wherein the instructions for determining a plurality of delta impact values effectuate operations further comprising:
determining a first plurality of impact values for a first record of the plurality of records, wherein each impact value in the first plurality of impact values indicates an influence a corresponding feature had on classifying the first record as an anomaly;
determining a second plurality of impact values for the data, wherein each impact value in the second plurality of impact values indicates an influence a corresponding feature had on classifying each record in the data; and
determining a plurality of delta impact values for the first record by determining a pairwise difference between the first plurality of impact values and the second plurality of values.

15. The medium of claim 14, wherein the instructions for determining a second plurality of impact values for the data effectuate operations further comprising averaging impact values of each record in the data.

16. The medium of claim 13, wherein the data comprises time series data corresponding to a first day, and wherein the second machine learning model is trained on a second data file corresponding to a predetermined number of days prior to the first day.

17. The medium of claim 13, wherein the instructions for determining that a first delta impact value of the plurality of delta impact values is greater than a threshold number of other delta impact values of the plurality of delta impact values effectuate operations further comprising:
ranking, based on the plurality of delta impact values, each feature of the first record; and
determining, based on the ranking, that the first feature is ranked in a top predetermined number of features.

18. The medium of claim 13, wherein outputting an indication that the first record corresponds to an anomaly is further based on a determination that a score of the plurality of scores that corresponds to the first record is above a threshold score.

19. The medium of claim 13, wherein outputting an indication that the first record corresponds to an anomaly is performed in response to:
sorting, based on the plurality of scores, each record of the data; and
determining that the first record is above a threshold order in the sorted data.

20. The medium of claim 13, wherein the instructions for determining that a first delta impact value of the plurality of delta impact values is greater than a threshold number of other delta impact values of the plurality of delta impact values comprises determining that the first delta impact value is greater than every other delta impact value.
